(19) United States
(12) Patent Application Publication
(10) Pub. No.: US 2004/0084092 A1
(43) Pub. Date: May 6, 2004

(54) Decouplable sea water suction strainer and pump assembly

(76) Inventors: Michael M. Bogart, Willoughby Hills, OH (US); William Liptak, West Palm Beach, FL (US)

Correspondence Address: Michael J. Corrigan, 2961 Quail Ridge, Akron, OH, 44319, US

(21) Appl. No.: 10/283,444

(22) Filed: Oct. 30, 2002

(51) Int. Cl. G05D 7/00

(52) U.S. Cl. 137/544

(57) ABSTRACT

The invention is a sea water suction strainer and pump assembly for drawing and filtering a fluid to be used for cooling or other purposes for machinery and the like requiring a supply of filtered water. A typical application is onboard a ship or boat where sea water is drawn and filtered for cooling the engines or supplied to the air conditioning plants. A sea water suction strainer is fluidly coupled to a sea water suction pump via a quick disconnect coupling so that the individual components can be removed separately from a special mounting plate. The special mounting plate is mounted onto the hull or bulkhead of a ship or boat. The mounting of the individual components directly adjacent another on the special mounting plate allows the individual components to be serviced and/or replaced quickly and conveniently.

### RELATED APPLICATIONS

There are no previously filed, nor currently any co-pending applications, anywhere in the world.

### BACKGROUND OF THE INVENTION

1. Field of the Invention

The present invention relates generally to water filtering and, more particularly to a decoupleable sea water suction strainer and pump assembly.

2. Description of the Related Art

The use of sea water suction strainers and water pumps are well known. Typically, a sea water strainer is located in the bilge of a boat or ship fluidly coupled to a sea water suction inlet generally located beneath the waterline. Sea water drawn from the sea is filtered of contaminants by a strainer inside the sea water suction strainer. Sea water is fed into the sea water strainer by the pressure head created by a pump and the difference in elevation of the sea water suction inlet and the sea water suction strainer. A sea water suction pump is generally located within the engine room of the boat or ship and is fluidly coupled to the sea water suction strainer located in a different location by piping. The sea water suction pump creates a pressure head for pumping the strained sea water to machinery for cooling and/or other purposes. Heretofore, there has been no effort addressed in the prior art to physically located the sea water suction strainer and the sea water suction pump in a juxtaposed relationship to ease in the maintenance of the sea water strainer assembly and the sea water suction pump. Occasionally, the strainer from the seawater suction strainer must be removed for cleaning and/or replacement. Additionally, the sea water suction pump requires maintenance such as replacing a damaged impeller and/or replacing the entire sea water suction pump. The present invention simplifies these maintenance requirements by physically locating the sea water suction strainer and the sea water suction pump adjacent one another mounted together on a mounting plate for convenient placement in the bilge of the ship or boat. The mounting bracket allows the entire assembly to be removed together and the quick disconnect coupling connecting the sea water suction strainer and the sea water suction pump allows each of these components to be conveniently removed from the mounting bracket independently of one another as required.

The present invention therefore fulfills a need not addressed in the prior art by providing a sea water suction strainer assembly that is conveniently located that can be easily removed or having components that can be removed individually.

### SUMMARY OF THE INVENTION

It is therefore an object of the present invention to provide an improved sea water suction strainer assembly.

It is another object of the present invention to provide an improved sea water suction strainer assembly that can be conveniently removed.

It is yet another object of the invention to an improved sea water suction strainer assembly that has components that can be removed independently of one another.

Briefly described according to one embodiment of the present invention, an improved sea water suction strainer assembly is provided comprised of a sea water suction strainer and a sea water suction pump each independently and removably mounted to a mounting bracket for conveniently mounting the assembly in the bilge of a boat or ship. The sea water suction strainer assembly can be used in ships and boats or other applications which require strained water to be supplied to machinery and the like for cooling, filtering or other purposes. For purposes of disclosure, the sea water suction strainer assembly is described having application to ships or boats sailing in fresh or salt water but this disclosure is not meant to be limiting. The sea water suction strainer is mounted adjacent to a sea water suction pump and both are removably mounted thereon by bolts or other suitable attachment means. The sea water suction strainer is fluidly coupled to the sea water suction pump by piping and a quick disconnect coupling. The quick disconnect coupling may be capable of establishing a leak proof connection by hand tightening and/or by a wrench such as a pipe wrench. The sea water suction strainer has a cover which is removable so that a strainer contained therein may be removed for cleaning and/or replacement.

### BRIEF DESCRIPTION OF THE DRAWINGS

The advantages and features of the present invention will become better understood with reference to the following more detailed description and claims taken in conjunction with the accompanying drawings, in which like elements are identified with like symbols, and in which:

FIG. 1 is a perspective view of an decouplable sea water suction pump strainer assembly installed on a cutaway view of a bulkhead section of a waterborne vessel;

FIG. 2 is an exploded perspective view of a decouplable sea water suction strainer assembly installed on a cutaway view of a bulkhead section of a waterborne vessel;

FIG. 3 is front view of a decouplable sea water suction strainer assembly installed on a cutaway view of a bulkhead section of a waterborne vessel; and

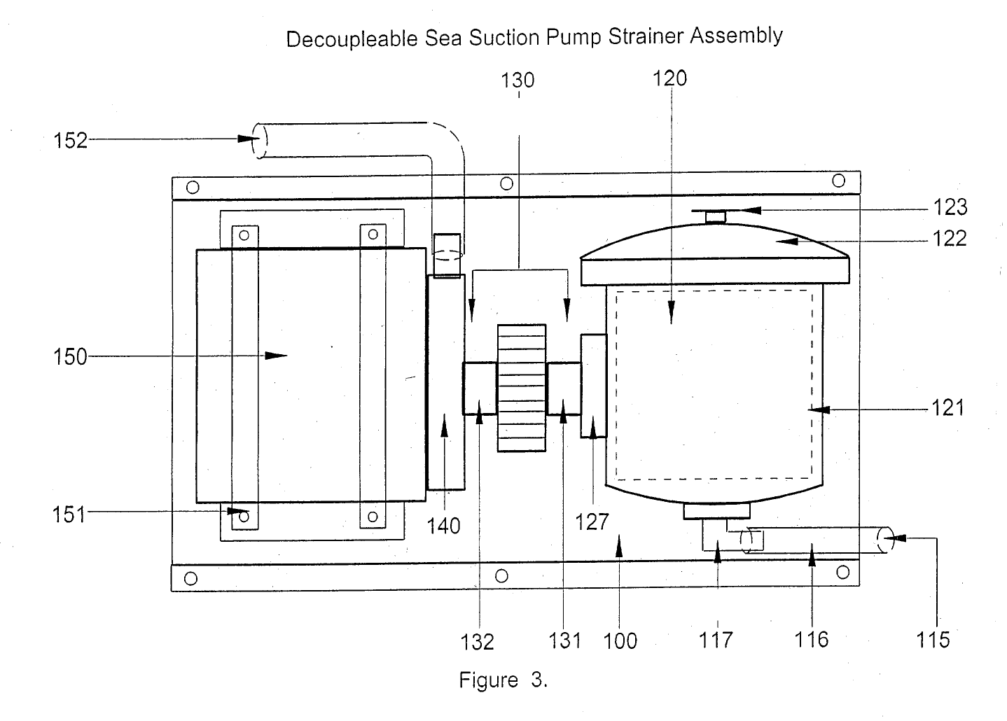

FIG. 4 is a cross-sectional view of a waterborne vessel showing a typical installation of the sea water suction strainer assembly installed on a bulkhead.

### DESCRIPTION OF THE PREFERRED EMBODIMENTS

The best mode for carrying out the invention is presented in terms of its preferred embodiment, herein depicted within the Figures.

1. Detailed Description of the Figures

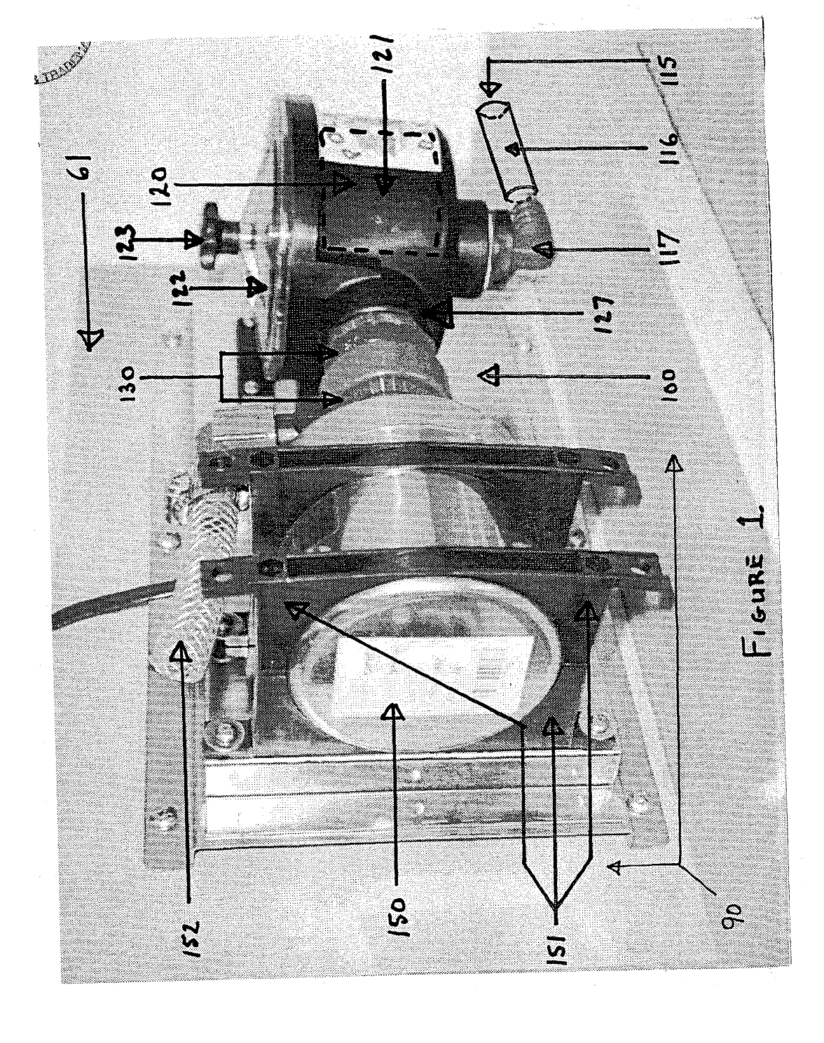

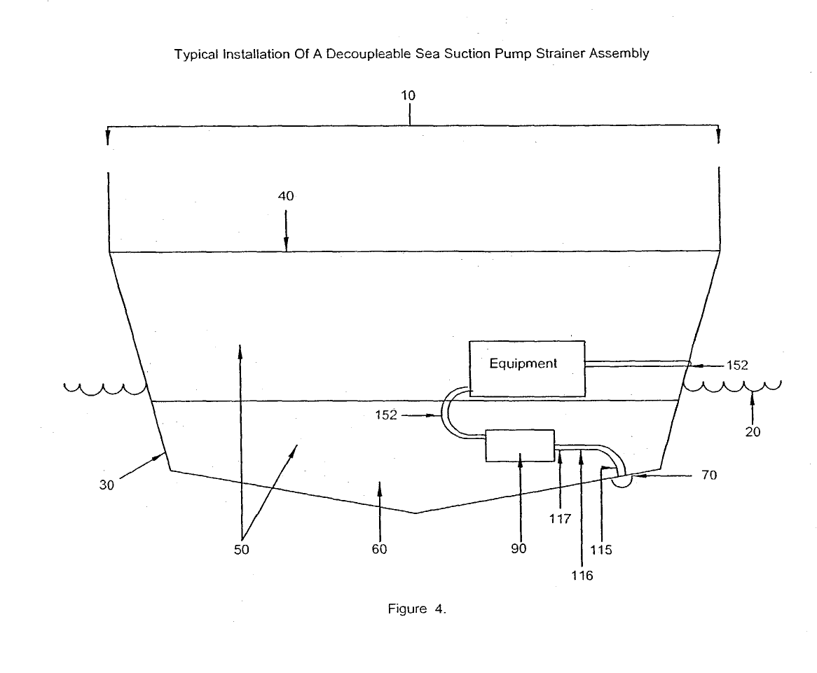

Referring now to FIG. 1, a perspective view of an entire decouplable sea suction strainer assembly 90 is shown, according to the preferred embodiment of the present invention. Typically, such a sea water suction strainer assembly 90 is installed (shown in FIG. 4) in a waterborne vessel 10 such as a boat, ship, or barge or any vehicle or vessel having a readily available source of cooling fluid such as water provided to onboard distilling units, air conditioning plants, and marine power plant cooling systems. The decouplable sea water suction strainer assembly 90 may have other applications and the disclosure presented herein is non-limiting. Sea water is drawn into the sea water suction strainer 120 by a sea water suction pump 150. The sea water suction strainer 120 removes particles such as grass, seaweed and barnacles from the cooling fluid to prevent particles from clogging or causing damage to the onboard distilling units, air conditioning plants, and marine power plant cooling systems. Periodically, the integral strainer basket 121 in the sea water suction strainer 120 will have to be cleaned of accumulated particles. Normally, the strainer basket 121 can be removed for cleaning or replacement without removing the entire sea water suction strainer 120 or sea water suction strainer and pump assembly 90. The sea water suction pump 150m also requires periodic maintenance and/or replacement. Typically, a sea water suction strainer and sea water suction pump may not be located in close physical proximity to each other. Consequently, the maintenance of the sea water suction strainer and sea water suction pump can often be laborious and time consuming and often requiring disassembly of other systems to gain access.

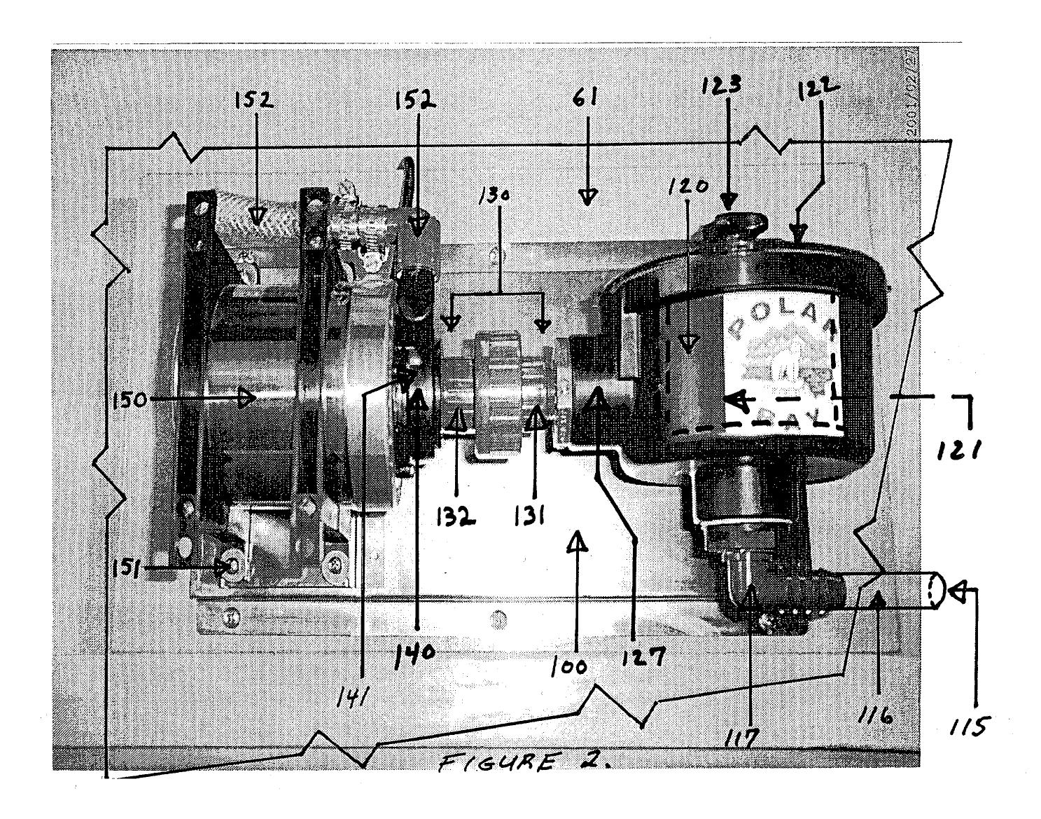

Referring now to FIG. 2, an exploded perspective view of an entire decouplable sea water suction strainer and pump assembly 90 is shown. The sea water suction strainer and pump assembly 90 is comprised of a sea water suction strainer 120 having a sea water suction strainer inlet 115, sea water suction strainer outlet 127, a housing 120, housing cover 122, and a removable strainer basket 121. Strainer basket 121 is removed periodically for cleaning, and if necessary, replacement. The sea water suction strainer and pump assembly 90 is further comprised of a sea water suction pump 150 powered by a prime mover such as an electric motor, rotary power from an internal combustion engine, or other power source. The sea water suction pump 150 motor has a fluid inlet 140, an impeller 141 (not shown), and fluid outlet 152. Fluidly connecting the sea water suction strainer 120 to the sea water suction pump 150 is a quick disconnect coupling 130 comprised of a male fitting 131 and female fitting 132. A cooling fluid such as sea water is drawn into the sea water suction strainer 120 by the suction created by the sea water suction pump 150 through piping 116 and sea water suction strainer inlet 117. Sea water passes through strainer basket 121 wherein waterborne particles are separated from the sea water. Sea water exits the sea water strainer 120 through sea water suction strainer outlet 127 and is directed to the sea water suction pump inlet 140 through quick disconnect coupling 130. The sea water suction pump outlet 152 is fluidly connected to onboard piping for further distribution to for further distribution to the onboard distilling units, air conditioning plants, and marine power plant cooling systems. Both sea water suction strainer 120 and sea water suction pump 150 have mounting brackets attached thereto for mounting. Sea water suction strainer 120 and sea water suction pump 150 are mounted on mounting plate 100 using u-brackets, c-clamps, or other fasteners. Sea water suction strainer 120 and sea water suction pump 150 are mounted adjacent one another being fluidly coupled together by quick disconnect coupling 130.

The installation of the decouplable sea water suction strainer and pump assembly 90 is shown on a bulkhead of a ship 10 as shown in FIG. 4.

The foregoing description is included to illustrate the operation of the preferred embodiment and is not meant to limit the scope of the invention. The scope of the invention is to be limited only by the following claims.

1. A fluid strainer and pump assembly, comprised of:
a fluid strainer;
a suction pump; and
a quick disconnect coupling;
wherein the fluid strainer is fluidly coupled to the suction pump by the quick disconnect and removably coupling in a juxtaposed relationship.

2. The improved fluid strainer and pump assembly of claim 1 further comprised of:
a mounting plate for mounting the improved fluid strainer and pump assembly so that the entire assembly may be removed for maintenance.

3. A seawater suction strainer and pump assembly, comprised of:
a sea water suction strainer;
a sea water suction pump; and
a quick disconnect coupling;
wherein the sea water suction strainer is fluidly coupled to the sea water suction pump by the quick disconnect coupling in a juxtaposed relationship.

4. The seawater suction strainer and pump assembly of claim 3, further comprised of:
a mounting plate wherein said sea suction strainer and said sea water suction are removably mounted.

5. A method of straining a fluid for cooling purposes comprised of the steps of:
providing a fluid strainer;
providing a suction pump juxtaposed to the fluid strainer;
fluidly connecting the fluid strainer to the suction pump via a quick disconnect coupling;
fluidly connecting the fluid strainer to a source of fluid;
drawing fluid from the source of fluid with the suction pump; and
discharging the fluid from the suction pump.
